(19) United States
(12) Patent Application Publication
(10) Pub. No.: US 2010/0169071 A1
(43) Pub. Date: Jul. 1, 2010

(54) UNIVERSAL SERIAL BUS (USB) NETWORK TRANSPORT METHODS AND APPARATUS

(75) Inventors: Miroslaw Oltuszyk, Drogheda (IE); David Tracey, Drogheda (IE)

Correspondence Address: WOLF GREENFIELD & SACKS, P.C., 600 ATLANTIC AVENUE, BOSTON, MA, 02210-2206, US

(73) Assignee: SIMtone Corporation (f/k/a XDS, Inc.), Durham, NC (US)

(21) Appl. No.: 12/609,609

(22) Filed: Oct. 30, 2009

Related U.S. Application Data
(60) Provisional application No. 61/109,587, filed on Oct. 30, 2008.

(51) Int. Cl. G06F 15/16; G06F 9/455

(52) U.S. Cl. 703/24; 709/219

(57) ABSTRACT

According to some aspects, a method of performing a Universal Serial Bus (USB) data transfer between a server and a USB device connected over a network, the data transfer including a plurality of transactions between the server and the USB is provided. The method comprises performing at least one of the plurality of transactions between the server and the USB device via a network communication and emulating locally at least one of the plurality of transactions expected to be performed via a network communication to reduce a number of the plurality of transactions that are performed via network communications.

### FIELD OF THE INVENTION

The present invention relates to using USB over a network, and more particularly, to methods and apparatus for decreasing delays of USB transmission over a network.

### BACKGROUND

Universal Serial Bus (USB) is a serial bus standard developed as a communication interface standard between a host computer and one or more interface devices. USB was designed to allow many peripherals to be connected using a single standardized interface socket and to address deficiencies in a variety of legacy serial and parallel port interfaces. A significant improvement in USB over other peripheral interfaces relates to improvements in plug-and-play capabilities and the ability to “hot swap” devices, that is, allowing devices to be connected and disconnected without rebooting the host computer and/or turning off the device. Other convenient features of USB include providing power to low-consumption devices without the need for an external power supply and allowing many devices to be used without requiring manufacturer specific, individual device drivers to be installed. The success of USB is evident in the widespread adoption of the USB standard and the ubiquity of USB capable host computers and peripheral devices.

USB communication comprises the transfer of packets between the host computer and the interface device. Packets come in three basic types: 1) handshake packets; 2) token packets; and 3) data packets. Handshake packets consist of a packet identifier (PID) byte, and are generally sent in response to data packets. The three basic types are ACK, indicating that data was successfully received, NAK, indicating that the data cannot be received at this time and should be retried, and STALL, indicating that the device has an error and will never be able to successfully transfer data until some corrective action (such as device initialization) is performed. USB 2.0 added two additional handshake packets, NYET which indicates that a split transaction is not yet complete, and an ERR handshake to indicate that a split transaction failed.

Token packets consist of a PID byte followed by 11 bits of address and a 5-bit CRC. Tokens are sent by the host computer to the interface device and include IN and OUT tokens containing a 7-bit device number and 4-bit function number (for multifunction devices) and command the device to transmit DATAx packets, or receive the following DATAx packets, respectively. An IN token expects a response from a device. The response may be a NAK or STALL response, or a DATAx frame. In the latter case, the host issues an ACK handshake if appropriate. An OUT token is followed immediately by a DATAx frame (see below). The device responds with ACK, NAK, or STALL, as appropriate. Another token packet is the NONE token, which does not expect a response.

Data packets include two basic data packets, DATA0 and DATA1. Both consist of a DATAx PID field, 0-1023 bytes of data payload (up to 1024 in high speed, at most 8 at low speed), and a 16-bit CRC. Such data packets are typically preceded by an address token, and are usually followed by a handshake token from the receiver back to the transmitter. The USB storage device packet transmission usually consists of an initial transmission and then the data transmission. The initial transmission consists of the first twenty (approximately) packets which initialize the attached USB device (such as sending device descriptors and setting up the configuration) and prepares the device to work. After that, there are repeated sequences of six packets consisting of three request/response pairs, with the actual user or device data being carried in only one (or two) of these packets. This sequence is repeated while the device is available (i.e. while the device is plugged in). All data transmissions (IN/OUT/NONE—the bulk data transfer) may be realized by this sequence of the six packets.

### SUMMARY

Some embodiments include a method of performing a Universal Serial Bus (USB) data transfer between a server and a USB device connected over a network, the data transfer including a plurality of transactions between the server and the USB, the method comprising performing at least one of the plurality of transactions between the server and the USB device via a network communication and emulating locally at least one of the plurality of transactions expected to be performed via a network communication to reduce a number of the plurality of transactions that are performed via network communications.

Some embodiments include at least one computer readable medium storing instruction that, when executed on at least one computer, perform a Universal Serial Bus (USB) data transfer between a server and a USB device connected over a network, the data transfer including a plurality of transactions between the server and the USB, the method comprising performing at least one of the plurality of transactions between the server and the USB device via a network communication and emulating locally at least one of the plurality of transactions expected to be performed via a network communication to reduce a number of the plurality of transactions that are performed via network communications.

Some embodiments include an apparatus for at least part of a Universal Serial Bus (USB) data transfer between a server and a USB device connected over a network, the data transfer including a plurality of transactions between the server and the USB, the apparatus comprising at least one input for receiving communications from the server and/or the network, at least one output for transmitting communications to the server and/or over the network, and at least one controller configure to perform at least one of the plurality of transactions between the server and the USB device via a network communication and emulate locally at least one of the plurality of transactions expected to be performed via a network communication to reduce a number of the plurality of transactions that are performed via network communications.

Some embodiments include an apparatus for at least part of a Universal Serial Bus (USB) data transfer between a server and a USB device connected over a network, the data transfer including a plurality of transactions between the server and the USB, the apparatus comprising at least one input for receiving communications from the USB device, at least one output for transmitting communications over the network, and at least one controller configure to perform at least one of the plurality of transactions between the server and the USB device via a network communication and emulate locally at least one of the plurality of transactions expected to be performed via a network communication to reduce a number of the plurality of transactions that are performed via network communications.

### BRIEF DESCRIPTION OF THE DRAWINGS

FIG. 1 illustrates a system wherein a server device communicates with a remote USB device over a network by intercepting USB requests using connector software;

FIG. 2A illustrates a conventional data transfers between a host and USB device according to the USB protocol's DATA-OUT transfer;

FIG. 2B illustrates a conventional data transfers between a host and USB device according to the USB protocol's DATA-IN transfer;

FIG. 2C illustrates a conventional data transfers between a host and USB device according to the USB protocol's NONE exchange;

FIG. 3 illustrates an exemplary data transfer for both a DATA-IN transfer and a DATA-OUT transfer over a network;

FIG. 4 illustrates a Command/Data/Status sequence for both a DATA-IN and DATA-OUT operation having a reduced number of network transactions, in accordance with some embodiments of the present invention;

FIG. 5 illustrates a Command/Status sequence for NONE operation having a reduced number of network transactions, in accordance with some embodiments of the present invention; and

FIGS. 6 and 7 illustrate stall recovery in view of network delays, in accordance with some embodiments of the present invention.

### DETAILED DESCRIPTION

USB is conventionally used for communication between a host computer and a locally connected device. The USB packets are therefore sent directly between the host computer and the local device. However, it may be advantageous to process USB packets over a network. For example, techniques for providing secure digital services over a network are described in U.S. Pat. No. 7,363,363 and US Publication No. 20050238034, which are incorporated herein by reference in their entireties. In such circumstances, wherein digital services are provided remotely, it may be beneficial to redirect USB communications over the network such that the remote service provider (server) communicates with the USB device over the network.

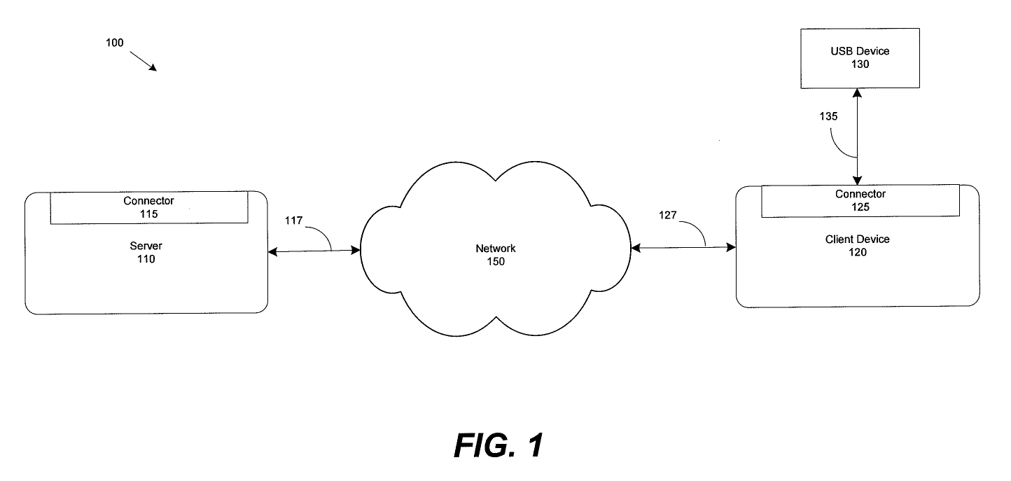

FIG. 1 illustrates a system wherein a server communicates with a remote USB device over a network by intercepting USB requests using connector software. System 100 includes a server 110 and a client device 120 having an established connection over network 150. Network 150 may be one or more networks of any type and configuration. For example, network 150 may include one or more private networks, local area networks (LAN), wide area networks (WAN), the Internet, etc. Server 110 may be any device capable of providing a service over network 150 and client device 120 may be any device capable of communicating over network 150. System 100 also includes a USB device 130 connected to the client device 120 via USB connection 135.

Client device 120 may include connector 125 in communication with USB device 130 and network 150. For example, connector 125 may have software that resides in the stack of the operating system to intercept USB requests coming from the USB device. The connector may then package the USB request and redirect the request over the network (e.g., via network link 127). The server may also include connector software 115 that obtains and unpacks the USB request and redelivers it to the operating system of server 110 as if the USB device 130 were connected directly to the server. That is, to server 110, USB device 130 appears to be locally connected to the server rather than connected over the network via client device 120.

The USB drivers on server 110 process the USB request. Any USB requests or packets sent back to the USB device are intercepted by connector software 115, packaged according to the protocol of the connectors and sent back over the network where connector 125 unpacks the communication and delivers it to USB device 130. In this way, server 110 communicates with USB device 130 as if the device were connected locally to the server. When redirecting USB traffic across a network (particularly a WAN), the delay in sending these packets (driver request) and waiting for responses (from the device) may cause performance problems. In the normal case of a locally attached device, the transmission delay between the driver and device is very small (when the device is used on the same machine where the driver is installed) and can be considered insignificant. When this USB traffic is redirected across a network, the delay between the host and the device may become significant, especially because of the sequence of the six small packets (exchanged between host and device) to transmit just one block of the data according to the USB protocol.

Applicant has appreciated that the number of packets sent over the network may be reduced by emulating locally at least some of the packets that conventionally would be sent over the network. According to some embodiments, the USB sequence of six packets conventionally transferred over the network is reduced to transmitting only two packets, thus making it possible to improve the transfer times between 50% and 70%, although any improvement may be suitable. However, other reductions in network transmission of USB packets may be achieved, as the aspects of the invention are not limited in this respect.

Following below are more detailed descriptions of various concepts related to, and embodiments of, methods and apparatus according to the present invention. It should be appreciated that various aspects of the invention described herein may be implemented in any of numerous ways. Examples of specific implementations are provided herein for illustrative purposes only. In addition, the various aspects of the invention described in the embodiments below may be used alone or in any combination, and are not limited to the combinations explicitly described herein.

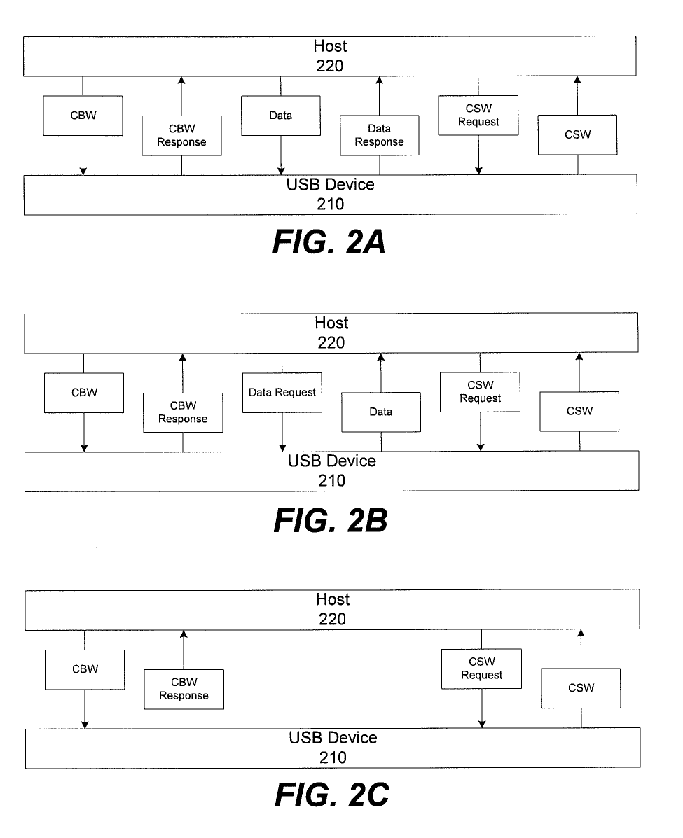

FIGS. 2A and 2B illustrate conventional data transfers between a host and USB device according to the USB protocol. At a high level, there are three main stages comprising a data transfer: 1) Command; 2) Data; and 3) Status. The Command stage in a data transfer involves the host requesting a data transfer (either a request to obtain data from the USB device, referred to as DATA-IN, or a request to provide data to the USB device, referred to as DATA-OUT) with the USB device. The Command stage typically involves the host sending a Command Block Wrapper (CBW) packet, the CBW packet defining whether the data transfer is a DATA-IN or DATA-OUT transfer (or NONE, as discussed below), how much data is being transferred and other information characterizing the requested data transfer.

The Data stage involves transferring the data itself and typically includes either the host transferring data to the USB device (DATA-OUT) or the USB device transferring data to the host (DATA-IN) via a data transport packet. The Status stage typically includes communicating the result of the request to transfer data by transferring a Command Status Wrapper (CSW) packet. Conventionally, each of the Command/Data/Status stages have a corresponding response or acknowledgment from the host/device receiving the corresponding packet (i.e., the stages may be composed of request/response pairs). Accordingly, six separate transactions typically occur for each transfer of a single data packet. FIG. 2A illustrates the six transactions for a DATA-IN transfer. FIG. 2B illustrates the six transactions for a DATA-OUT transfer. The data transfers illustrated in FIGS. 2A and 2B and described above are merely exemplary and other sequences may be used to implement the Command/Data/Status transfer, as the aspects of the invention are not limited in this respect.

FIG. 2C illustrates another type of communication between a host and a USB device using the USB protocol. The communication in FIG. 2C is performed when the CBW packet indicates that the communication is of the NONE type. The NONE communication may be used as a heartbeat between the host and the USB device. Because no data is transferred during the NONE operation, the NONE operation takes the form of Command/Status and only four transactions need to be performed to complete the NONE operation. The NONE operation illustrated in FIG. 2C and described above is merely exemplary and other sequences may be used to implement the Command/Status transfer, as the aspects of the invention are not limited in this respect.

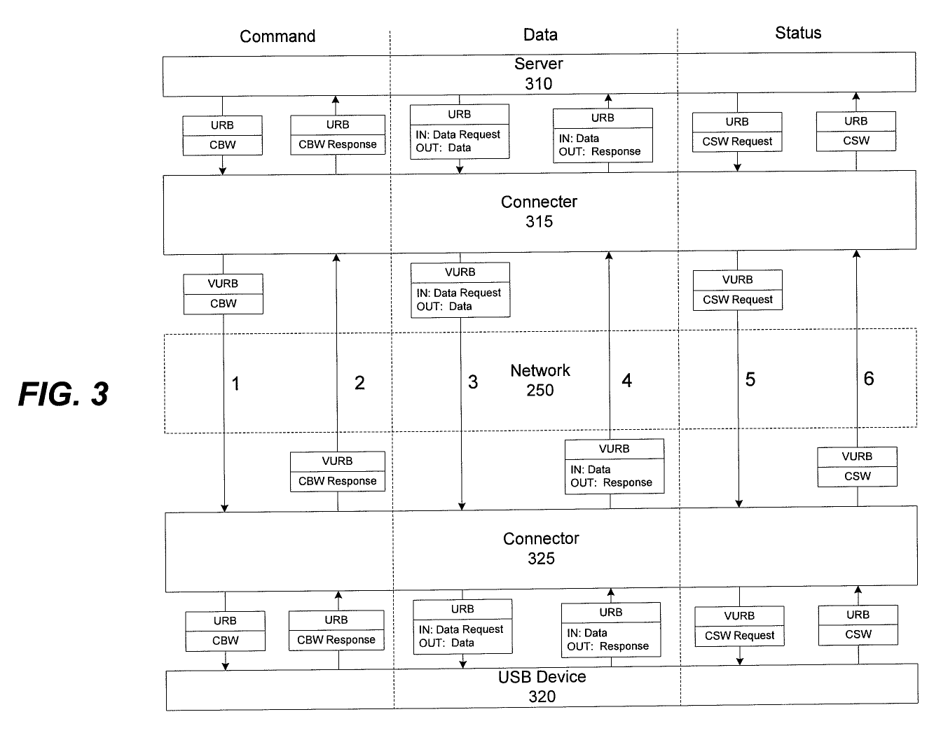

As discussed above, the above described protocol may be satisfactory when the USB device is attached locally to the host. However, with USB data transfers over a network (e.g., as described in connection with FIG. 1), the relatively numerous transactions for each data packet may cause noticeable delay communications between the USB device and a remote host or server. FIG. 3 illustrates the six network transactions that may be involved in the transfer of one data packet between a server communicating with a USB device over a network. In particular, FIG. 3 illustrates one example of a USB Command/Data/Status sequence over a network between server 310 and USB device 320, using connectors 315 and 325.

FIG. 3 illustrates an exemplary data transfer for both a DATA-IN transfer and a DATA-OUT. In the Data stage of the transfer, the data transport packet describes what the packet includes for a DATA-IN transfer (labeled as “IN”) and a DATA-OUT transfer (labeled as “OUT”). Connector 315 may be situated from a communications stand-point between the server 310 and the network 350. Similarly, connector 325 may be situated from a communications stand-point between USB device 320 and network 350. The connectors may be used to translate USB request blocks (URB) into virtual USB request blocks (VURB) and vice versa. A URB refers to a packet, whether the packet be associated with a Command, Data or Status communication. The VURB structure includes information needed to send the URBs across the network.

As discussed above, the connectors intercept URBs on both ends and may operate as a translation layer between the URB and VURB structure. The connectors may operate according to any protocol agreed upon by the connectors that are capable of transforming URBs into VURBs that can be transmitted over the network. As illustrated in FIG. 3, each of the Command, Data and Status operations include two transactions (e.g., a request and a response transaction). Thus, the exemplary USB Command/Data/Status sequence illustrated in FIG. 3 performed to transfer one packet of data involves six network communications. Accordingly, network delays may cause the data transfer to become unsatisfactorily slow.

It should be appreciated that many USB communications involve tens, hundreds and even thousands of data transfers, rendering the relatively numerous network communications particularly problematic. For example, a typical pen drive (e.g., a jump drive or memory stick) sends about 1800 packets for all its initialization data so that the pen drive's files can be seen by the host. These 1800 packets consist of about 20 basic initialization packets (i.e. descriptors) and the rest of the packets contain the directories and file information, each sent in sequences of six packets as described above for the bulk data transfer mode. If the network delay for one packet is takes 150-200 ms, the initialization time for this pen drive will be approximately 4.5-6 min. The number of packets sent during initialization of the mass storage device depends on the type of the device, size of the device, the amount of the directories and files stored on the device.

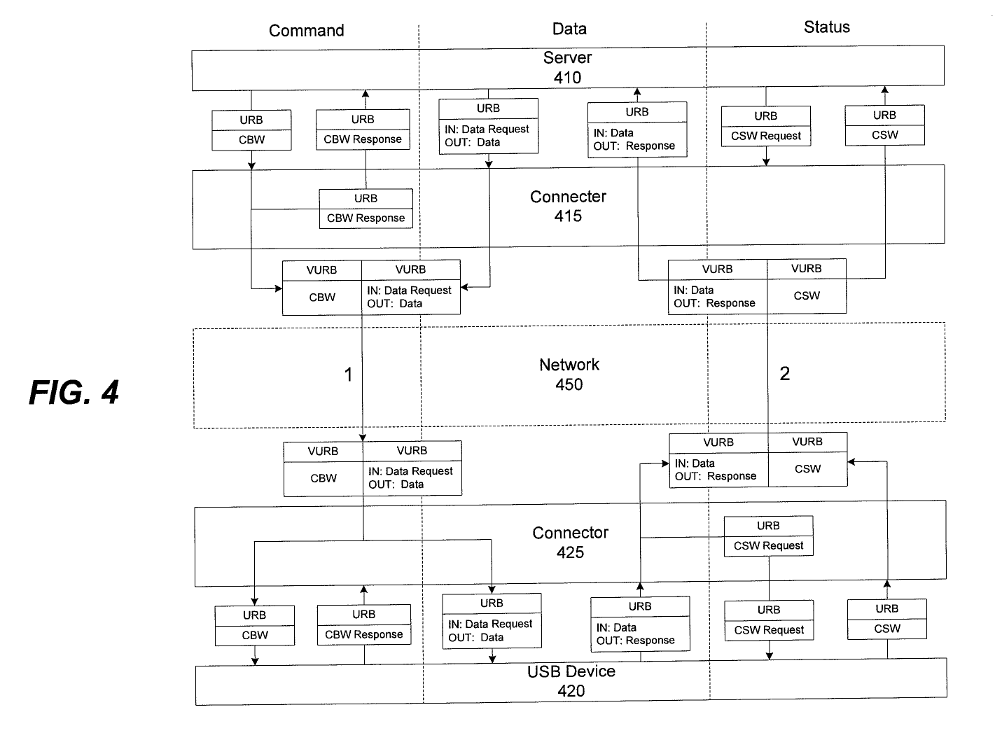

FIG. 4 illustrates a Command/Data/Status sequence for both a DATA-IN and DATA-OUT operation having a reduced number of network transactions, in accordance with some embodiments of the present invention. Initially, it should be appreciated that the network communications of the Command/Data/Status sequence in FIG. 4 has been reduced from the six network communications shown in FIG. 3 to two network communications. According to some embodiments, this may be achieved by emulating locally at least some of the transactions that are expected to be received from the other side of the network. In some embodiments, the emulation is performed by the connectors to, in essence, trick either the server or the USB device into believing that an expected transaction from the other device has been received by emulating the expected transaction locally, as discussed in further detail below.

In FIG. 4, the data transfer is initiated by server 410 issuing a CBW packet to begin the Command phase of the sequence. Since server 410 is a USB configured device, server 410 will wait for the CBW Response from USB device 420 before beginning the Data stage. To expedite performance of the data transfer, connector 415 may emulate the CBW response and provide the response to server 410. Believing that the server's CBW has been acknowledged, server 410 may then proceed to the Data stage by transmitting the URB with the data for the transfer (DATA-OUT) or transmit a URB requesting the data from the USB device (DATA-IN), as shown by the “OUT” label and “IN” label shown in the data transport URB/VURB in FIG. 4. It should be appreciated that at this stage, USB device 420 still has not received anything from server 410 and therefore no network communications have occurred.

After server 410 generates the data transport URB, connector 415 combines the CBW URB and the data transport URB and translates the combined packet into a VURB suitable for being transmitted over network 450. The VURB may then transmitted over network 450 and received by connector 425. Connector 425 translates the VURB into two separate URBs. Specifically, connector 425 splits the VURB into the CBW packet and the data transport packet. The CBW packet is provided to USB device 420, which in turn generates and transmits the CBW Response which is intercepted by connector 425. Because a CBW response has been emulated locally on the server side of the network, the CBW response from USB device 420 need not be transmitted over the network. Accordingly, connector 425 may discard the CBW response and provide USB device 420 with the data transport URB. In the case of a DATA-OUT operation, USB device 420 will have thus received the data. In the case of a DATA-IN operation, USB device 420 will have received a data request.

USB device 420 may now be prepared to respond appropriately to the data transport URB. In particular, if the data transfer is a DATA-OUT operation, USB device 420 will generate a data response URB and if the data transfer is a DATA-IN operation, USB device will generate the requested data. In any event, the data transport URB transmitted by USB device 420 is intercepted by connector 425. Rather than immediately sending the data transport URB, connector 425 may emulate a CSW Request that conventionally would have been received over the network from server 410 after the server received the data transport URB. In response to receiving the emulated CSW request, USB device 420 may generate a CSW URB to be transmitted to server 410 to provide status information to the server. At this point, it appears to the USB device 420 that the data transfer is complete and the device may wait until another CBW packet is received.

Connector 425 intercepts the CSW URB and combines the CSW packet with the data transport packet and translates the packets into a combined VURB. The combination VURB may then be transported over network 150 and received by connector 415. Connector 415 then translates and splits the VURB into a data transport URB and a CSW URB. The connector may then provide the data transport URB to server 410. Independent of whether the operation is a DATA-OUT operation (wherein the data transport URB includes a data response) or a DATA-IN operation (wherein the data transport URB includes the requested data), server 410 may generate a CSW Request packet to be sent to USB device 420. Because USB device 420 has already received the emulated CSW Request, connector 415 may discard the CSW Request and in response, provide server 410 with the CSW URB from the USB device. After receiving the CSW URB, the data transfer is complete.

Thus, by locally emulating at least some of the transactions, the number of network communications may be reduced. For example, in the example in FIG. 4, by emulating locally the responses, the network communications needed to complete a data transfer can be reduced from six to two. It should be appreciated that emulating the responses allows portions of the Command/Data/Status operation to be combined, thus consolidating the number of network communications that are needed. It should be appreciated that one or more transactions may be emulated in different combinations/configurations to achieve any reduction in the number of network communications required to perform a data transfer, as the aspects of the invention are not limited in this respect.

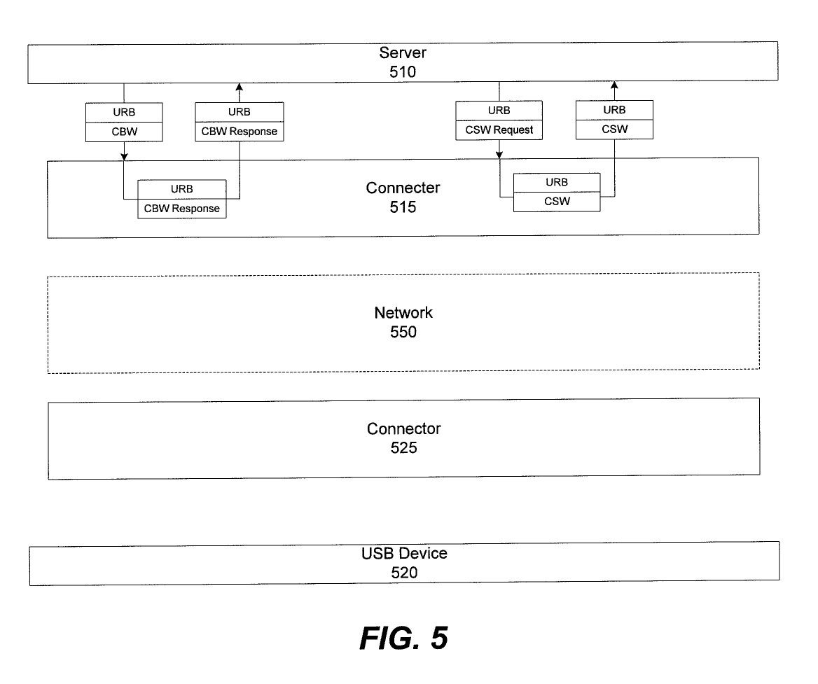

As discussed above, the USB specification defines another operation that does not include the transfer of any data. In particular, the NONE operation may be used as a heartbeat communication to establish periodically that a USB device is connected and available. In conventional USB communications, the NONE heartbeat communications are not problematic. However, in networked environments, the four network transactions may cause unacceptable delays. According to some embodiments, responses to the NONE operation are simulated on the server side of the network such that no network communications are performed, as illustrated in FIG. 5.

In the NONE operation of FIG. 5, a CBW request from server 510 is not sent over the network and a CBW Response is emulated by connector 515 and sent back to the server. Similarly, when server 510 sends a CSW request packet, this packet is not sent over the network and a CSW packet is emulated by connector 515 and sent back to the server. This method avoids network communications with the USB device if it is not necessary. To handle circumstances wherein communication between the server and USB device has really been lost, the NONE operation can be performed over the network every nth time a heartbeat sequence is generated by the server rather than being emulated, where n is any number deemed suitable for the operation of the system.

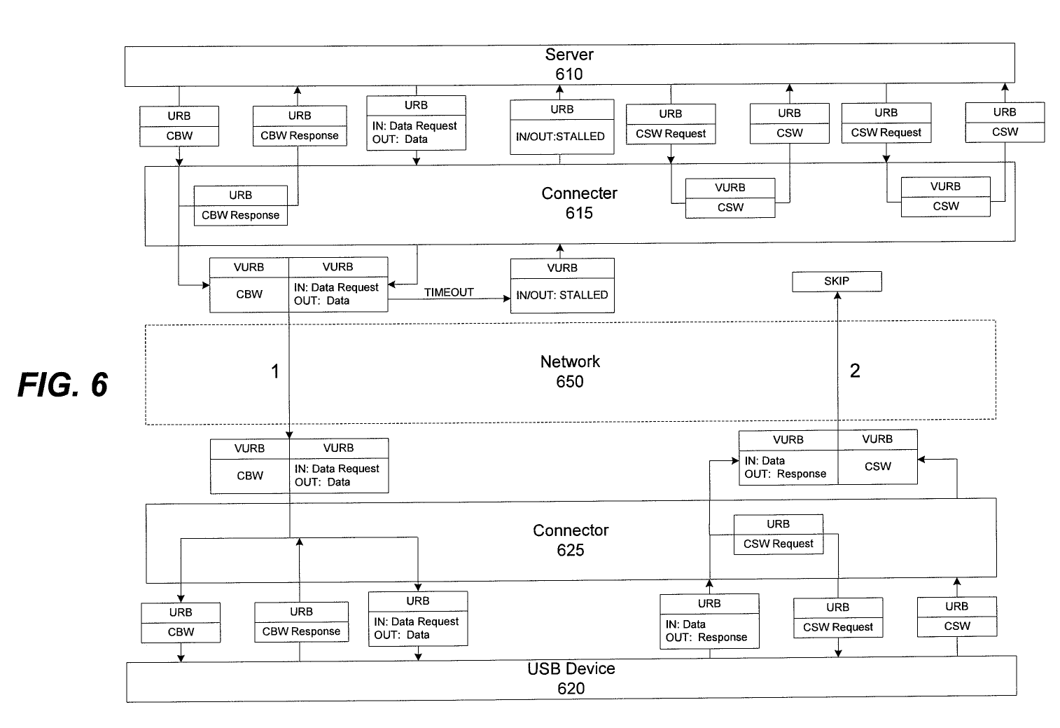

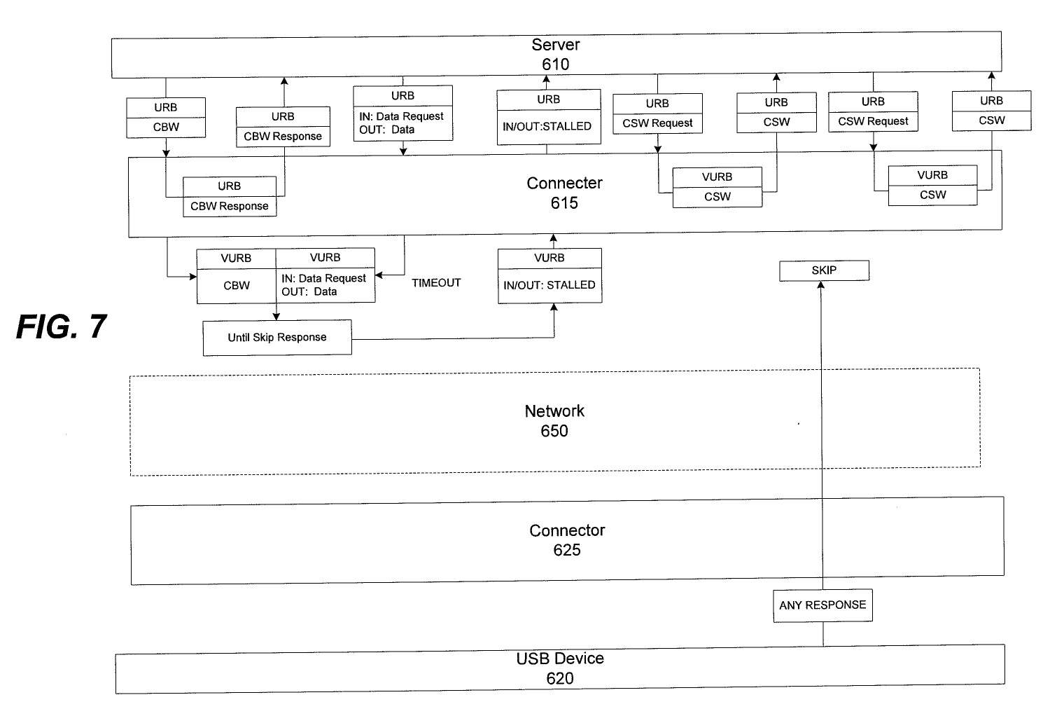

Even in circumstances of reduced network communications, some network delay may be unavoidable. In some cases, this delay may result in one of the packets (URBs) being delayed longer than the USB response timeout (USB response timeout is about 10 seconds). If the server doesn't receive a response in the expected time, it will normally end the communication with the USB device. Such circumstances may be handled by the exemplary processes illustrated in FIGS. 6 and 7.

FIG. 6 shows the start of the reset sequence. If server 610 does not receive a response from USB device 620 in the expected time (e.g., 9 seconds, which is shorter than the response timeout in the driver) then connector 615 will emulated and send the STALLED status to server 610. Server 610 may then send the RESET PIPE request and the response for that request is emulated locally by the connector and sent to server 610. The server may then attempt to end the transfer by sending the CSW request and the response is again emulated locally by the connector and sent to the server. The server may repeat the last data request sequence (e.g., the last IN/OUT data transfer sequence), which may be passed through to the USB device if the delayed device response packet is received. In cases where no response is received, the reset sequence may be repeated a number of desired times after which a disconnect event may be generated (see e.g., FIG. 7).

In the above drawings, the connectors are shown standalone software/hardware components. However, the connectors may be part of, embedded in, or attached to other devices, as the aspects of the invention are not limited in this respect. For example, the to connector on the USB device side of the network may be associated with or part of a stateless network appliance (SNAP) are an other device capable of communicating over a network. A stateless device refers herein to a device that can operate substantially as a network and display management device. In particular, the stateless device may operate chiefly as a human interface device to a network when operating in its stateless capacity. A stateless device typically does not run any applications or download any software other than software that performs network functionality and displays information received over the network. As a result, a stateless device (when operating in its stateless capacity) need not perform substantial user functionality and/or contain any significant and/or permanent user data.

Enabling a stateless device to access, interact with and/or receive services from other network devices mitigates and/or eliminates one or more problems associated with conventional network computing. For example, stateful computing devices are largely responsible for a number of security issues such as providing user functionality that facilitates hacking, establishing a computational environment to both host and spread viruses, and/or otherwise enabling a user to breach security, attack vulnerabilities in a network environment, and/or otherwise exploit the functionality of stateful devices.

A stateless device, by contrast, is largely stripped of the functionality that facilitates the various capabilities described above. However, a stateless device in conjunction with the above described architecture, permit the stateless device to operate as a so-called “dumb terminal,” yet still benefit from resources available over the network. In particular, a stateless device may simulate any computing environment without requiring the device itself to be enabled with the associated functionality. For example, a stateless device, interacting with a network service, may access a user's Windows™ environment without requiring the Windows™ operating system to be installed on the stateless device. Since the stateless device is operating as an interface to the network, it may be presented information over the network that allows it to simulate any device or functionality, without requiring the attendant drawbacks associated with the requirement that the functionality be resident on the stateless device.

Stateless devices facilitate a shift in network computing from a paradigm in which the computational and functional burden is on the device connecting to the network (e.g., a laptop or PC) to a paradigm in which functionality and computation may be chiefly performed by servers connected to the network. Amongst some of the advantages described above, this new paradigm allows devices that traditionally do not enjoy, or enjoy limited network capabilities (e.g., televisions, or any other device having a display) to become fully network capable devices. Stateless devices present a relatively inexpensive means to fully interact with and access services over one or more networks, while preserving the integrity of data maintained by hosts/servers to which the stateless device is interacting/interfacing.

It should be appreciated that a stateful device (such as a personal computer, personal digital assistant, etc.) may operate in a stateless capacity. That is, a stateful device may operate as a stateless device by suppressing, to some extent, its full capability as a stateful device such as executing applications, storing user data and information, etc. Purely stateless devices, though, operate substantially as a network appliance that allow a user to interface with information on a network that is stored elsewhere, and/or to receive services and functionality that is computed, performed and provided from some other location on the network (e.g., by one or more hosts or servers to which the network appliance is connected).

It should be appreciated that embodiments may be used to enabled network devices to interface and operate USB devices even though the network device may not have the appropriate drivers for the local USB device. That is, if the network device can connect to a remote server that has the appropriate drivers, the network device can operate the USB device via the networked USB communications described herein.

The above-described embodiments of the present invention can be implemented in any of numerous ways. For example, the connectors may be a single component or a collection of components and may be implemented using hardware, software or a combination thereof. When implemented in software, the software code can be executed on any suitable processor or collection of processors, whether provided in a single computer or distributed among multiple computers. It should be appreciated that any component or collection of components (e.g., a connector or connector software) that perform the functions described above can be generically considered as one or more controllers that control the above-discussed function. The one or more controller can be implemented in numerous ways, such as with dedicated hardware, or with general purpose hardware (e.g., one or more processor) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code. In this respect, it should be appreciated that one embodiment of the invention is directed to a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. The invention is capable of other embodiments and of being practiced or of being carried out in various ways.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of performing a Universal Serial Bus (USB) data transfer between a server and a USB device connected over a network, the data transfer including a plurality of transactions between the server and the USB, the method comprising:
performing at least one of the plurality of transactions between the server and the USB device via a network communication; and
emulating locally at least one of the plurality of transactions expected to be performed via a network communication to reduce a number of the plurality of transactions that are performed via network communications.

2. The method of claim 1, wherein emulating locally includes emulating at least one response transaction.

3. The method of claim 2, wherein emulating locally includes emulating local to the server a Command Block Wrapper (CBW) response packet expected to be received over the network from the USB device.

4. The method of claim 1, wherein emulating locally includes locally emulating at least one request transaction.

5. The method of claim 4, wherein emulating locally includes emulating local to the USB device a Command Status Wrapper (CSW) request expected to be received over the network from the server.

6. The method of claim 1, wherein the data transfer is a DATA-IN transfer requiring two network communications.

7. The method of claim 1, wherein the data transfer is a DATA-OUT transfer requiring two network communications.

8. At least one computer readable medium storing instruction that, when executed on at least one computer, perform a Universal Serial Bus (USB) data transfer between a server and a USB device connected over a network, the data transfer including a plurality of transactions between the server and the USB, the method comprising:
performing at least one of the plurality of transactions between the server and the USB device via a network communication; and
emulating locally at least one of the plurality of transactions expected to be performed via a network communication to reduce a number of the plurality of transactions that are performed via network communications.

9. The at least one computer readable medium of claim 10, wherein emulating locally includes emulating at least one response transaction.

10. The at least one computer readable medium of claim 9, wherein emulating locally includes emulating local to the server a Command Block Wrapper (CBW) response packet expected to be received over the network from the USB device.

11. The at least one computer readable medium of claim 10, wherein emulating locally includes locally emulating at least one request transaction.

12. The at least one computer readable medium of claim 11, wherein emulating locally includes emulating local to the USB device a Command Status Wrapper (CSW) request expected to be received over the network from the server.

13. The at least one computer readable medium of claim 10, wherein the data transfer is a DATA-IN transfer requiring two network communications.

14. The at least one computer readable medium of claim 10, wherein the data transfer is a DATA-OUT transfer requiring two network communications.

15. An apparatus for at least part of a Universal Serial Bus (USB) data transfer between a server and a USB device connected over a network, the data transfer including a plurality of transactions between the server and the USB, the apparatus comprising:
at least one input for receiving communications from the server and/or the network;
at least one output for transmitting communications to the server and/or over the network; and
at least one controller configure to perform at least one of the plurality of transactions between the server and the USB device via a network communication and emulate locally at least one of the plurality of transactions expected to be performed via a network communication to reduce a number of the plurality of transactions that are performed via network communications.

16. The apparatus of claim 15, wherein the at least one controller is configured to emulate locally at least one response transaction.

17. The at least one computer readable medium of claim 16, wherein the at least one controller is configured to emulate local to the server a Command Block Wrapper (CBW) response packet expected to be received over the network from the USB device and provide the emulated CBW response packet to the server.

18. An apparatus for at least part of a Universal Serial Bus (USB) data transfer between a server and a USB device connected over a network, the data transfer including a plurality of transactions between the server and the USB, the apparatus comprising:
at least one input for receiving communications from the USB device;
at least one output for transmitting communications over the network; and
at least one controller configure to perform at least one of the plurality of transactions between the server and the USB device via a network communication and emulate locally at least one of the plurality of transactions expected to be performed via a network communication to reduce a number of the plurality of transactions that are performed via network communications.

19. The at least one computer readable medium of claim 18, wherein the at least one controller is configured to emulate locally at least one request transaction.

20. The at least one computer readable medium of claim 19, wherein the at least one controller is configured to emulate local to the USB device a Command Status Wrapper (CSW) request expected to be received over the network from the server and provide the emulated CSW packet to the USB device.
